(19) United States
(12) Patent Application Publication
(10) Pub. No.: US 2006/0236027 A1
(43) Pub. Date: Oct. 19, 2006

(54) Variable memory array self-refresh rates in suspend and standby modes

(76) Inventors: Sandeep Jain, Milpitas, CA (US); Jun Shi, San Jose, CA (US); Animesh Mishra, Pleasanton, CA (US); David Wyatt, San Jose, CA (US); Paul Diefenbaugh, Portland, OR (US); Pochang Hsu, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/093,706

(22) Filed: Mar. 30, 2005

(51) Int. Cl. G06F 13/28

(52) U.S. Cl. 711/106

(57) ABSTRACT

Self-refresh rates of a memory unit may be managed based on temperature. In one embodiment of the invention, the invention may include measuring the temperature of a memory unit, the memory unit having a self-refresh rate to maintain data integrity, comparing the measured temperature to a threshold, and adjusting the self-refresh rate of the memory unit based on the comparison.

### BACKGROUND

1. Technical Field

The present disclosure relates to power consumption in computer systems and, in particular, to controlling the refresh rate of solid state memory banks.

2. Related Art

As the temperature of a solid state RAM (random access memory) increases, the memory loses charge at a faster rate. If the memory loses charge, then it loses the data that was stored in its memory cells. RAM chips have self-refresh circuitry that restores the lost charge at periodic intervals. The interval is chosen to be short enough that there is virtually no risk that data is lost or corrupted.

The temperature of RAM is largely determined by its activity level (rate of reads and writes into the memory cells) and its environment. The increased rate of charge loss generates more heat, and the increased heat increases the rate at which the charge is lost. In addition, each self-refresh cycle requires power. For a computer in a standby state, the power required to self-refresh the memory may be a significant portion of total consumed power. As the amount of system memory in computer systems increases, the self-refresh power may become an increasingly larger share of the total system power consumption. For battery-powered systems, such as notebook computers, PDAs (Personal Digital Assistants), tablet computers, music players and portable telephones, the memory refresh cycle may have a significant effect on battery life. For systems plugged into mains current, the refresh cycle increases the operating cost of the system.

In addition newer memory chip designs require even shorter self-refresh intervals. For DDR2 and DDR3 (Double Data Rate) chips, a doubled self-refresh rate is required at higher memory chip temperatures (e.g. temperatures over 85C). The 2× self-refresh rate is defined as twice the self-refresh rate for DDRAM (Double Data Rate Synchronous Dynamic RAM). This puts further demands on the power reserves of the computing system.

In order to reduce the refresh rates of a memory chip or bank, system or subsystem, some information about its temperature must be known. The more accurate the temperature information, the more the refresh rate may be reduced. If the temperature information is not reliable or accurate, then the memory will be run at a faster refresh rate then necessary in order to provide some margin for error.

To be effective, the temperature information should be provided to some system that can apply it to adjust the self-refresh rate. In a separate effort to reduce power consumption, many systems offer various suspend, standby and hibernation states. One such state is known as STR (Suspend to RAM). In STR, the current state of the system is stored in system RAM, while most of the system hardware is powered down. As a result, the RAM becomes the most significant power user and also the only source of information for waking the system from STR.

If a system enters STR or another low-power state when the memory is hot and operating at a high refresh rate, then it is likely that after some time in the low-power mode, the memory will cool down. The self-refresh rate may then be reduced, saving power and allowing the memory to cool still faster. However, many low-power states power off the circuitry that otherwise would be able to adjust the self-refresh rate, such as processors, memory controllers, and input/output hubs, while the system is in the low-power state.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of a portion of a computer system according to an embodiment of the invention;

FIG. 2 is a block diagram of a portion of a computer system according to another embodiment of the invention;

FIG. 3 is process flow diagram of adjusting a self-refresh rate of a memory unit based on temperature according to an embodiment of the invention;

FIG. 4 is process flow diagram of adjusting a self-refresh rate of a memory unit based on temperature in a suspend to RAM state according to an embodiment of the invention;

FIG. 5 is process flow diagram of adjusting a self-refresh rate of a memory unit based on temperature in a suspend to RAM state according to an embodiment of the invention; and

FIG. 6 is a block diagram of a computer system suitable for implementing embodiments of the present invention.

### DETAILED DESCRIPTION

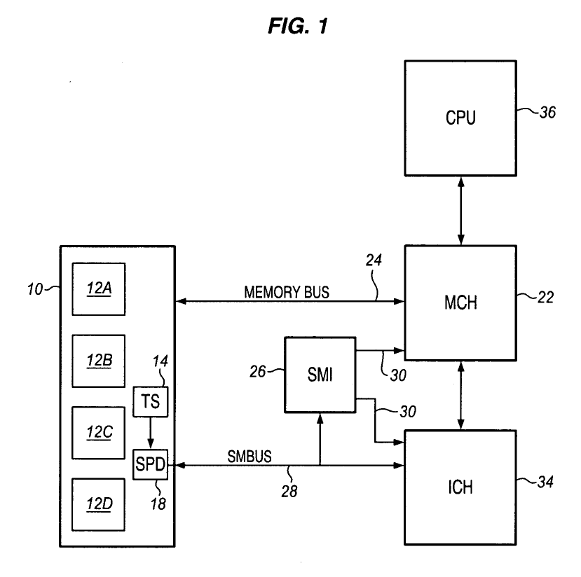

FIG. 1 shows a memory unit 10 that has a plurality of memory devices 12 (12a-12n) and a temperature measurement module 14 coupled to the memory devices 12. The memory unit 10 may be a SO-DIMM (small outline dual inline memory module) of the type typically used in notebook personal computers (PCs). The SO-DIMM 10 may have a 240-pin, 144-pin, or 72-pin configuration that supports 64-bit transfers, or any other of a wide variety of different pin configurations for different transfer rates that correspond to a DIMM (Dual In-line Memory Module) structure or any other structure. The memory unit 10 may alternatively be a micro DIMM, or a full-size DIMM, more commonly used in desktop PCs. Furthermore, the memory devices 12 may be SDRAM (synchronous dynamic random access memory) devices, which have relatively high current surge transients and can therefore, be highly susceptible to overheating. Embodiments of the present invention may be applied, however, to any type of memory device that requires a self-refresh at a rate that depends, at least in part on temperature.

A temperature measurement module 14 measures an internal temperature of one or more of the memory devices 12 either directly or indirectly. The temperature measurement module may use thermal sensors in one or more of a variety of different locations. The memory unit includes several SDRAM devices 12a, 12b, 12c, 12d. While four SDRAM devices have been shown, a greater or smaller number of memory devices may be used. A serial presence detect (SPD) device 18 in the memory unit is coupled to the thermal sensor to drive the sensor and receive a temperature measurement.

The memory unit 10 is coupled to an MCH (memory controller hub) 22, though a memory bus 24, and the SPD of the memory unit is coupled to an ICH (Input/Output Controller Hub) 34 through a SMBus 28. In addition to storing configuration information (e.g., module size, data width, speed and voltage) used by the basic input/output system (BIOS, not shown) at system start-up, the SPD device 18 is able to transfer internal temperatures of the SDRAM devices 12 to a system management interface 26. The system management interface 26 can generate interrupts and control signals on interrupt lines 30 if the memory unit temperatures exceed temperature thresholds, and to wake aspects of the system from a low-power state.

In particular, the illustrated system management interface 26 includes a system management bus 28 coupled to the SPD device 18. The system management interface 26 receives the internal temperatures from the SPD device 18 over the system management bus 28, and compares the internal temperatures to the temperature threshold.

In one example, the system management bus 28 is an I2C (inter integrated circuit) bus (e.g., I2C Specification, Version 2.1, Phillips Semiconductors, January 2000), which can physically consist of two active wires and a ground connection. The active wires, termed serial data line (SDA) and serial clock line (SCL) are both bidirectional.

The system management bus 28 can also operate under a SMBus framework (e.g., SMBus Specification, Version 2.0, SBS Implementers Forum, August 2000). An SMBus interface uses I2C as its backbone, and enables components to pass messages back and forth rather than tripping individual control lines. Such an approach is particularly useful for a system memory in a personal computer architecture.

The ICH is coupled to the MCH and also to a CPU (Central Processing Unit) 36 which sends data to and fetches data from the system memory 10. In the illustrated embodiment, the system memory sends and receives memory data to and from the MCH and the MCH controls the memory's refresh rate. The ICH communicates stored data from the system memory to other devices (not shown). Any one or more of these three devices may be consolidated into a single unit. The MCH may be incorporated into the CPU or the ICH and the functions of all three devices may be combined into a single chip. While in a wake state, the sensed temperature from the ICH can be sent to the MCH or the CPU which may then adjust the refresh rate. In a low-power state the MCH and the CPU may be powered down. The ICH, typically coupled to a keyboard, network interface, and other devices, waits for interrupts that will wake the system.

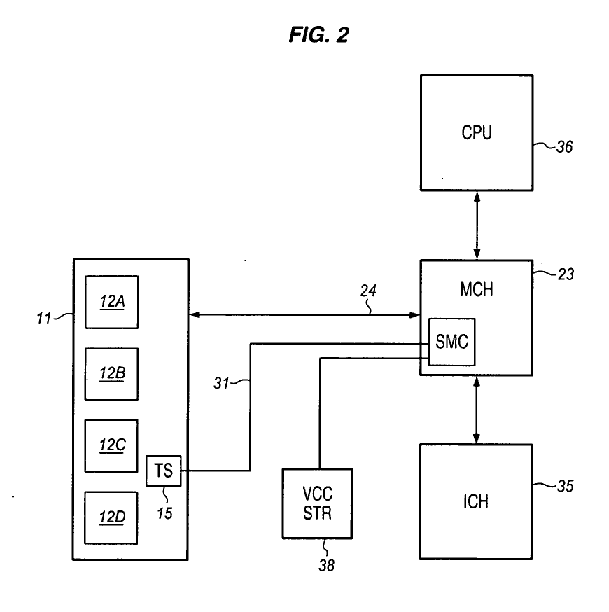

FIG. 2 shows an alternative to the configuration of FIG. 1, although the two approaches may be combined. In FIG. 2, the memory module 11, similar to memory unit 10, has a set of DRAM chips 12A-12N (only four are shown) or other memories and a temperature sensor 18, which may include an SPD. The memory module is coupled through a memory bus to a memory controller 23. In FIG. 2, the MCH includes a self-refresh management circuit 27 that may sit on its own power well. In the example of FIG. 2, the self-refresh management circuit is coupled to a separate STR power supply 38. In STR mode, while the normal power (VCC) to most of the components is shut off, the power from the STR power supply is still supplied. The STR power supply may be used to power the memory module and other components in addition to the self-refresh management unit.

The temperature sensor is coupled on an event bus 31, such as I2C or SMBus to the self-refresh management circuit in order to send temperature information to the self-refresh management circuit. Since both components remain powered during STR mode, they can communicate even when other components are inactive. The temperature sensor and the self-refresh management unit are able to perform self-refresh management functions while the system is in a low-power state, such as STR. In contrast to the example of FIG. 1, however, the self-refresh management circuit is coupled directly to the self-refresh control circuitry (not shown) of the MCH on which it resides. This allows the self-refresh state to be changed without waking the MCH or the CPU and without affecting an ICH 34 or the CPU 36.

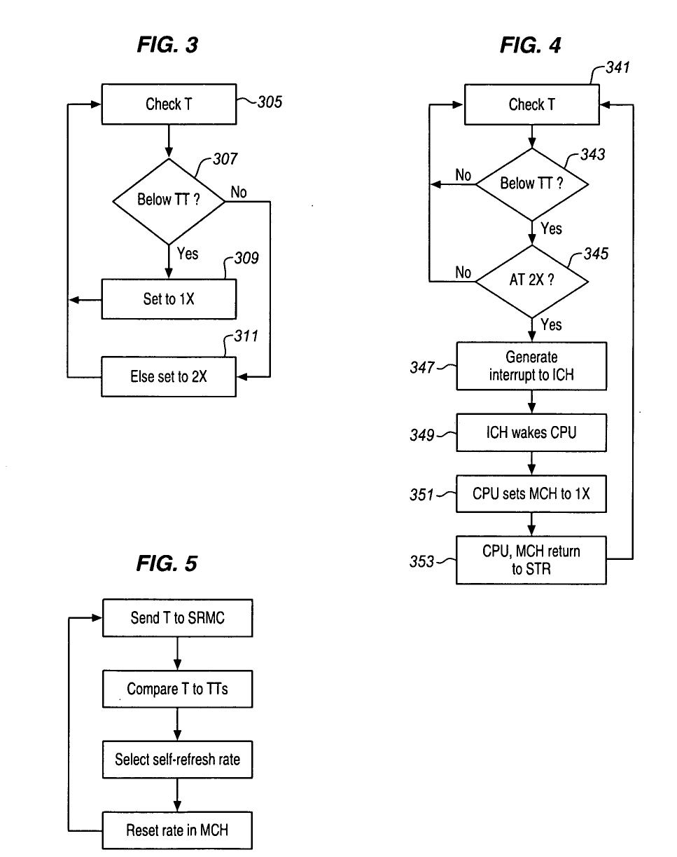

FIG. 3 shows a generalized flow of events for adjusting the self-refresh rate of a memory unit, such as the memory unit 10 or 11 of FIGS. 1 and 2, based on temperature. For a DDR2 or DDR3 memory unit, the individual SDRAM units may be operated at self-refresh rates identified as 1× and 2×, depending on the internal temperature of the respective SDRAM unit. The 1× rate requires less power and generates less heat, while the 2× rate ensures that the stored data stays intact at higher temperatures. The self-refresh is performed over the memory bus by the MCH in the architectures shown in FIGS. 1 and 2, but the CPU sets the self-refresh rate. In an alternative embodiment, the MCH independently determines and sets the self-refresh rate.

As shown in FIG. 3, during normal operation, the temperature of the memory is checked at block 305. This may be done by the SPD sending temperature data to the system management interface, to the ICH, or to the MCH. The temperature is then compared to a thermal threshold (TT) at block 307. This may be performed in the SPD, the system management interface, the ICH, the MCH, or even the CPU. If the temperature is below the threshold, then the self-refresh rate is set to 1× at block 309. If the temperature is above the threshold, then the self-refresh rate is set to 2× at block 311. To set the self-refresh rate, the CPU may program the MCH to the new rate. A set bit in the MCH may indicate the current rate so that a command is sent only to change the rate or the command may be sent regardless of the current rate. The rate is changed only if the command indicates a different rate.

If the computer system is set to a low-power state, such as STR, then the CPU, MCH and portions of the ICH will be powered down or placed in a suspend mode. This may prevent the CPU from programming the MCH and may prevent the MCH from receiving a command to change the self-refresh rate. It also shuts down communications on the buses used to control the self-refresh rate, such as the memory bus and the bus between the MCH and CPU. As shown in FIG. 4, the thermal sensor and the SPD may be configured so that they continue to operate. At block 341, the temperature is checked 341. This may be done in the system management interface which remains powered for just this purpose. The system management interface may then check to determine if the temperature is below the thermal threshold at block 343. If the temperature remains high, then the temperature check may be repeated after some interval of time.

If the temperature is below the threshold, then at block 345, the current self-refresh rate may be checked. If it is already set to 1×, then the process may return to check the temperature again later. If the self-refresh rate is set to 2×, then the system management interface may generate an interrupt to the ICH at block 347. At block 349, the ICH receives the interrupt and wakes the CPU. The CPU may then command the MCH to set the self-refresh rate to 1× at block 351. This may require that aspects of the MCH be waked or the MCH may be in a partially or full wake state already. At block 353, any components that were waked may return to the standby or low-power state, such as STR.

The process of FIG. 4 allows a system to slow down a memory self-refresh state after a memory cools down. It allows the self-refresh state to be changed from 2× to 1× even when the components that control the self-refresh state are powered down or in a standby state. The process may be modified to accommodate more self-refresh rates by adding additional temperature thresholds. Accordingly, the memory may be taken from 4×, to 2×, to 1×, to ½×, to ¼×, etc. and to any desired states in between. Similarly, the temperature comparisons may also be used to increase the self-refresh rate if the memory temperature were to increase.

Additional operations may also be performed after the system is commanded to enter STR mode. The MCH, SPD, or system management interface may check the self-refresh rate. If the self-refresh rate is already at 1×, then the FIG. 4 process may be disabled. Similarly, if the self-refresh rate is at 2×, then the FIG. 4 process may be enabled. The temperature may also be checked before entering STR to determine whether the self-refresh rate is appropriate. It may be possible to set the self-refresh rate to 1× immediately before entering STR mode. In one embodiment, the self-refresh rate is maintained at 2× all during normal operations. The process of FIG. 3 is not performed. Upon receiving a STR command, the temperature is checked, and if the temperature is low enough, then the self-refresh rate is set to 1×. Upon waking, the self-refresh rate is reset to 2×, regardless of the temperature.

FIG. 5 shows an example of a simplified process that may be performed using the configuration shown in FIGS. 1 and 2. At block 341, the thermal system on the memory module sends a temperature to the self-refresh management circuit. As mentioned above, this temperature may reflect the temperature of one or more of the individual memory chips on the module. It may be a combined temperature, an average temperature or a set of temperatures. At block 507, the self-refresh management unit compares the received temperature or temperatures to one or more thermal thresholds. As suggested above in DDR2 and DDR3 memory, one threshold may be set at 85C, however additional thresholds at lower temperatures may allow for further reductions in the self-refresh rate. Additional higher temperature thresholds may allow a memory module to maintain data even at higher temperatures.

At block 509, the self-refresh management unit selects a self-refresh rate based on the temperature comparison and at block 511, it resets the self-refresh rate within the MCH. If the self-refresh management circuit is resident on the MCH, then it may be provided with direct access to the self-refresh circuitry of the MCH independent of the CPU or any other components. Alternatively, it may be provided with circuitry to wake the MCH for purposes of resetting the self-refresh rate. It may alternatively send a command that emulates a command from the CPU to reset the self-refresh rate.

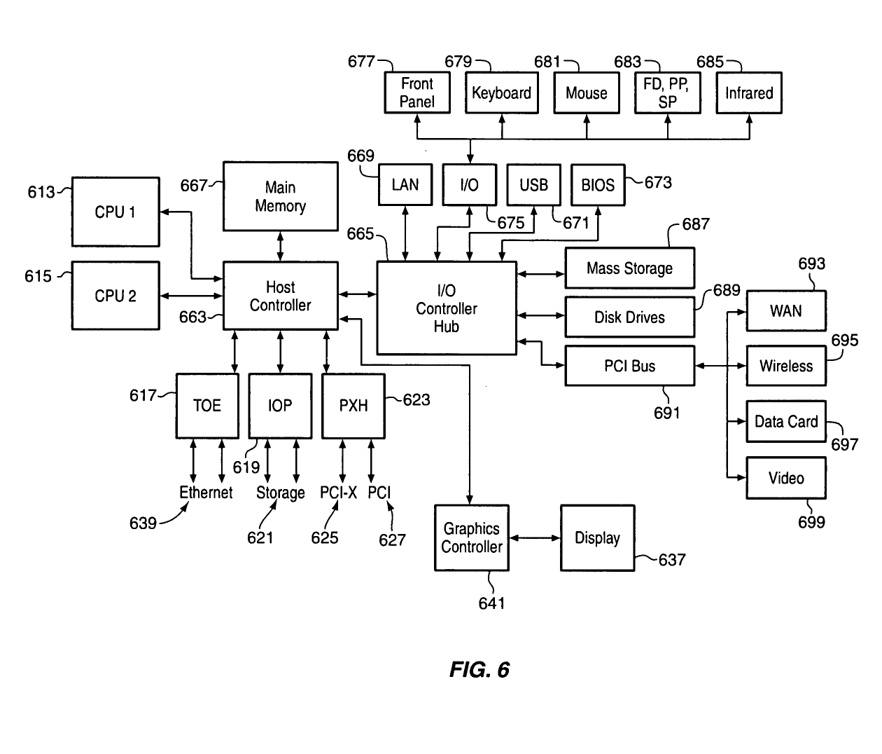

FIG. 6 shows an example of a computer system suitable for incorporating an embodiment of the present invention. A MCH chip, north bridge, or host controller 663 interfaces one or more CPUs (central processing unit) 613, 615 with memory and I/O devices and may provide a wide range of features such as increased performance, reliability, availability and serviceability, system management and hot plug exchange of CPUs. The MCH may include I/O clusters, a memory controller, snoop filters, and a wide range of logic for handling transactions. While the example of FIG. 6 includes a microprocessor coupled to a MCH and an ICH (Input/Output Controller Hub) 665, either the MCH or the ICH or both or any of the functions of these chips may be incorporated into the microprocessors. The MCH and the ICH may also be combined, in whole or in part, inside of or outside of the microprocessor.

In the example of FIG. 6, the MCH 611 has a pair of FSBs (front side bus) each coupled to a CPU or processor core 613, 615. More or less than two processor cores and FSBs may be used. Any number of different CPUs and chipsets may be used. The north bridge receives and fulfills read, write and fetch instructions from the processor cores over the FSBs. The north bridge also has an interface to system memory 667, such as DIMMs (Dual In-line Memory Modules) similar to those shown in FIGS. 1 and 2, in which instructions and data may be stored, and an interface to an ICH (input/output controller hub) 665.

The MCH also has an interface, such as a PCI (peripheral component interconnect) Express, or AGP (accelerated graphics port) interface to couple with a graphics controller 641 which, in turn provides graphics and possible audio to a display 637. The PCI Express interface may also be used to couple to other high speed devices. In the example of FIG. 6, six ×4 PCI Express lanes are shown. Two lanes connect to a TCP/IP (Transmission Control Protocol/Internet Protocol) Offload Engine 617 which may connect to network or TCP/IP devices such as a Gigabit Ethernet controller 639. Two lanes connect to an I/O Processor node 619 which can support storage devices 621 using SCSI (Small Computer System Interface), RAID (Redundant Array of Independent Disks) or other interfaces. Two more lanes connect to a PCI translator hub 623 which may support interfaces to connect PCI-X 625 and PCI 627 devices. The PCI Express interface may support more or fewer devices than are shown here. In addition, while PCI Express and AGP are described, the MCH may be adapted to support other protocols and interfaces instead of, or in addition to those described.

The ICH 665 offers possible connectivity to a wide range of different devices. Well-established conventions and protocols may be used for these connections. The connections may include a LAN (Local Area Network) port 669, a USB hub 671, and a local BIOS (Basic Input/Output System) flash memory 673. A SIO (Super Input/Output) port 675 may provide connectivity for a front panel 677 with buttons and a display, a keyboard 679, a mouse 681, and infrared devices 685, such as IR blasters or remote control sensors. The I/O port may also support floppy disk, parallel port, and serial port connections. Alternatively, any one or more of these devices may be supported from a USB, PCI or any other type of bus or interconnect.

The ICH may also provide an IDE (Integrated Device Electronics) bus or SATA (serial advanced technology attachment) bus for connections to disk drives 687, 689 or other large memory devices. The mass storage may include hard disk drives and optical drives. So, for example, software programs, parameters or user data, may be stored on a hard disk drive or other drive. A PCI (Peripheral Component Interconnect) bus 691 is coupled to the ICH and allows a wide range of devices and ports to be coupled to the ICH. The examples in FIG. 6 include a WAN (Wide Area Network) port 693, a Wireless port 695, a data card connector 697, and a video adapter card 699. There are many more devices available for connection to a PCI port and many more possible functions. The PCI devices may allow for connections to local equipment, or nearby computers. They may also allow for connection to various peripherals, such as printers, scanners, recorders, displays and more. They may also allow for wired or wireless connections to more remote equipment or any of a number of different interfaces.

The particular nature of any attached devices may be adapted to the intended use of the device. Any one or more of the devices, buses, or interconnects may be eliminated from this system and other may be added. For example, video may be provided on the PCI bus, on an AGP bus, through the PCI Express bus or through an integrated graphics portion of the host controller.

It is to be appreciated that a lesser or more equipped memory unit, memory module, thermal sensor, thermal management, or computer system than the example described above may be preferred for certain implementations. Therefore, the configuration of the examples provided above may vary from implementation to implementation depending upon numerous factors, such as price constraints, performance requirements, technological improvements, or other circumstances. Embodiments of the present invention may also be adapted to other types of memory systems and to other thermal environments than the examples described herein. The particular types of standby and power modes described herein may also be adapted to suit different applications.

Embodiments of the present invention may be provided as a computer program product which may include a machine-readable medium having stored thereon instructions which may be used to program a general purpose computer, mode distribution logic, memory controller or other electronic devices to perform a process. The machine-readable medium may include, but is not limited to, floppy diskettes, optical disks, CD-ROMs, and magneto-optical disks, ROMs, RAMs, EPROMs, EEPROMs, magnet or optical cards, flash memory, or other types of media or machine-readable medium suitable for storing electronic instructions. Moreover, embodiments of the present invention may also be downloaded as a computer program product, wherein the program may be transferred from a remote computer or controller to a requesting computer or controller by way of data signals embodied in a carrier wave or other propagation medium via a communication link (e.g., a modem or network connection).

In the description above, numerous specific details are set forth. However, it is understood that embodiments of the invention may be practiced without these specific details. For example, well-known equivalent materials may be substituted in place of those described herein, and similarly, well-known equivalent techniques may be substituted in place of the particular processing techniques disclosed. In other instances, well-known circuits, structures and techniques have not been shown in detail to avoid obscuring the understanding of this description.

While the embodiments of the invention have been described in terms of several examples, those skilled in the art may recognize that the invention is not limited to the embodiments described, but may be practiced with modification and alteration within the spirit and scope of the appended claims. The description is thus to be regarded as illustrative instead of limiting.

What is claimed is:

1. A method comprising:
measuring the temperature of a memory unit, the memory unit having a self-refresh rate to maintain data integrity;
comparing the measured temperature to a threshold; and
adjusting the self-refresh rate of the memory unit based on the comparison.

2. The method of claim 1, wherein measuring comprises reading the voltage of a thermal diode embedded in a random access memory module of the memory unit.

3. The method of claim 1, wherein measuring comprises receiving a temperature value from a temperature circuit of the memory unit.

4. The method of claim 3, wherein comparing comprises comparing the received temperature to a stored temperature in a self-refresh management circuit.

5. The method of claim 4, wherein the self-refresh management circuit is incorporated into a memory controller that drives the self-refresh rate of the memory unit.

6. The method of claim 1, wherein adjusting comprises generating an interrupt to a memory controller that drives the self-refresh rate of the memory unit.

7. The method of claim 1, wherein adjusting comprises generating an event to a memory controller that drives the self-refresh rate of the memory unit.

8. The method of claim 1, further comprising setting the memory in a standby mode before measuring, comparing and adjusting.

9. The method of claim 1, wherein comparing and adjusting is performed in a standby mode by a circuit having its own power well independent of the standby state.

10. An article including a machine readable medium containing data, that when executed by the machine causes the machine to perform operations comprising:
measuring the temperature of a memory unit, the memory unit having a self-refresh rate to maintain data integrity;
comparing the measured temperature to a threshold; and
adjusting the self-refresh rate of the memory unit based on the comparison.

11. The medium of claim 10, wherein measuring comprises reading the voltage of a thermal diode embedded in a random access memory module of the memory unit.

12. The medium of claim 10, wherein measuring comprises receiving a temperature value from a temperature circuit of the memory unit.

13. The medium of claim 10, wherein adjusting comprises generating an interrupt to a memory controller that drives the self-refresh rate of the memory unit.

14. The medium of claim 10, wherein adjusting comprises generating an event to a memory controller that drives the self-refresh rate of the memory unit.

15. The medium of claim 10, further comprising setting the memory in a standby mode before measuring, comparing and adjusting.

16. An apparatus comprising:
a thermal sensor to measure the temperature of a memory unit, the memory unit having a self-refresh rate to maintain data integrity; and
a self-refresh management circuit to adjust the self-refresh rate of the memory unit based on the measured temperature.

17. The apparatus of claim 16, wherein the thermal sensor is resident on the memory unit and the self-refresh management circuit is external to the memory unit, the apparatus further comprising a bus connecting the thermal sensor and the memory unit to allow the thermal sensor to send the temperature information to the self-refresh management circuit.

18. The apparatus of claim 17, wherein the self-refresh management circuit is incorporated into a memory controller that drives the self-refresh rate of the memory unit and wherein the bus connects the memory unit to the memory controller.

19. The apparatus of claim 16, wherein the self-refresh management circuit is coupled to a power well that is powered during a memory standby state.

20. An apparatus comprising:
a memory controller;
a processor coupled to the memory controller;
a memory unit coupled to the memory controller, the memory unit having a self-refresh rate controlled by the memory controller to maintain data integrity;
a thermal sensor within the memory unit to measure the temperature of the memory unit; and
a self-refresh management circuit coupled to the thermal sensor to adjust the self-refresh rate of the memory unit based on the measured temperature.

21. The apparatus of claim 20, wherein the self-refresh management circuit is to adjust the self-refresh rate by generating an interrupt to the memory controller that drives the self-refresh rate of the memory unit.

22. The apparatus of claim 20, further comprising a standby power well to power the memory unit and the self refresh management circuit when the memory controller and the processor are in a standby state.
